(19) United States
(12) Patent Application Publication
(10) Pub. No.: US 2026/0179038 A1
(43) Pub. Date: Jun. 25, 2026

(54) INFORMATION PROCESSING APPARATUS

(71) Applicant: NEC Corporation, Tokyo (JP)

(72) Inventor: Koji ICHIKAWA, Tokyo (JP)

(73) Assignee: NEC Corporation, Tokyo (JP)

(21) Appl. No.: 19/414,484

(22) Filed: Dec. 10, 2025

(30) Foreign Application Priority Data
Dec. 19, 2024 (JP) 2024-223782

(51) Int. Cl. G06Q 10/087

(52) U.S. Cl. CPC G06Q 10/08726

(57) ABSTRACT

An information processing apparatus of the present disclosure includes: a calculating unit that calculates a second inventory standard, which is a target value of a first inventory standard to be a standard of an inventory quantity of a product, based on the second inventory standard in past; an adjusting unit that changes and adjusts a value of the first inventory standard based on the inventory quantity and the second inventory standard; and an output unit that outputs the adjusted first inventory standard. Consequently, automated decision making in inventory management by artificial intelligence is facilitated.

### INCORPORATION BY REFERENCE

This application is based upon and claims the benefit of priority from Japanese patent application No. 2024-223782, filed on Dec. 19, 2024, the disclosure of which is incorporated herein in its entirety by reference.

### TECHNICAL FIELD

The present disclosure relates to an information processing apparatus.

### BACKGROUND ART

Product inventory management is of critical importance in stores engaged in product sales. For example, Patent Literature 1 describes determining whether the inventory is insufficient or excessive based on the number of products in stock and the number of products shipped.

### CITATION LIST

### Patent Literature

Patent Literature 1: Japanese Unexamined Patent Application Publication No. JP-A 2021-039532

### SUMMARY OF INVENTION

### Technical Problem

However, even in the case that it is determined whether the product inventory is insufficient or excessive based on the shipment quantity as described in Patent Literature 1, it is difficult to predict the subsequent shipment quantity, and it is difficult to determine an appropriate replenishment quantity of products. As a result, there arises a problem that it is difficult to appropriately manage the product inventory.

Accordingly, an object of the present disclosure is to solve the abovementioned problem that it is difficult to appropriately manage the product inventory.

### Solution to Problem

An information processing apparatus as an aspect of the present disclosure includes: a calculating unit configured to calculate a second inventory standard, which is a target value of a first inventory standard to be a standard of an inventory quantity of a product, based on the second inventory standard in past; an adjusting unit configured to change and adjust a value of the first inventory standard based on the inventory quantity and the second inventory standard; and an output unit configured to output the adjusted first inventory standard.

Further, an information processing method as an aspect of the present disclosure includes: calculating a second inventory standard, which is a target value of a first inventory standard to be a standard of an inventory quantity of a product, based on the second inventory standard in past; changing and adjusting a value of the first inventory standard based on the inventory quantity and the second inventory standard; and outputting the adjusted first inventory standard.

Further, a program as an aspect of the present disclosure includes instructions for causing an information processing apparatus to execute processes to: calculate a second inventory standard, which is a target value of a first inventory standard to be a standard of an inventory quantity of a product, based on the second inventory standard in past; change and adjust a value of the first inventory standard based on the inventory quantity and the second inventory standard; and output the adjusted first inventory standard.

### Advantageous Effects of Invention

With the configurations as described above, the present disclosure facilitates appropriate management of the product inventory.

### BRIEF DESCRIPTION OF DRAWINGS

FIG. 1 is a block diagram showing an example of a configuration of an information processing apparatus according to the present disclosure;

FIG. 2 is a flowchart showing an example of processing operation by the information processing apparatus according to the present disclosure;

FIG. 3 is a diagram showing an example of data related to the present disclosure;

FIG. 4 is a diagram showing an example of data related to the present disclosure;

FIG. 5 is a diagram showing an example of data related to the present disclosure;

FIG. 6 is a block diagram showing an example of a hardware configuration of an information processing apparatus according to the present disclosure;

FIG. 7 is a block diagram showing an example of a configuration of the information processing apparatus according to the present disclosure; and

FIG. 8 is a flowchart showing an example of processing operation by the information processing apparatus according to the present disclosure.

### EXAMPLE EMBODIMENT

### First Example Embodiment

A first example embodiment of the present disclosure will be described with reference to the drawings. The drawings may be related to any example embodiment.

An information processing apparatus 10 in the present disclosure is used for determining an appropriate replenishment quantity for products when performing product inventory management, as an example. More specifically, in this example embodiment, in product inventory management, by updating and setting an inventory standard, which is the standard of the inventory quantity of a product, and a target inventory standard, which is the target value thereof, it is facilitated to determine a more appropriate replenishment quantity for the product based on the current product inventory quantity and the inventory standard.

In the following description, a case where a product whose inventory is mainly managed is one item will be illustrated, but the present disclosure can also be applied to a case where the inventories of multiple items of products are collectively managed. In addition, in the present disclosure, the interval between timings of updating the inventory standard and the target inventory standard and determining the replenishment quantity of the product is expressed as “period” and may be any interval such as day, week, month, or quarter. For example, in a case where “period” is “day”, an order is placed in the night of the previous day and the product is received in the morning of the day, and the daytime of the same day is demand during the period, and the night of the same day is the end of the period.

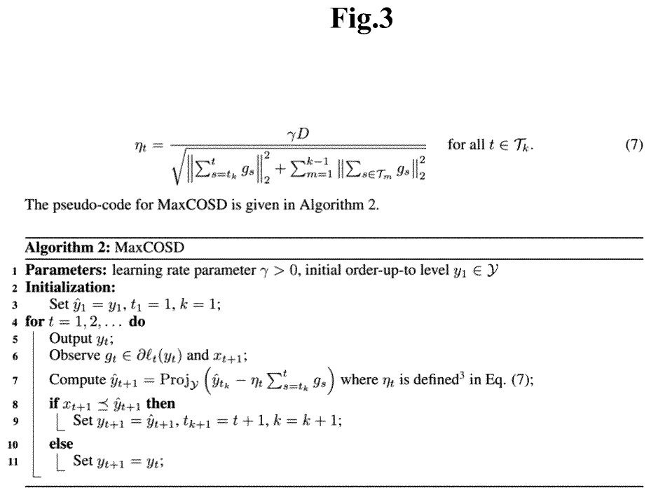

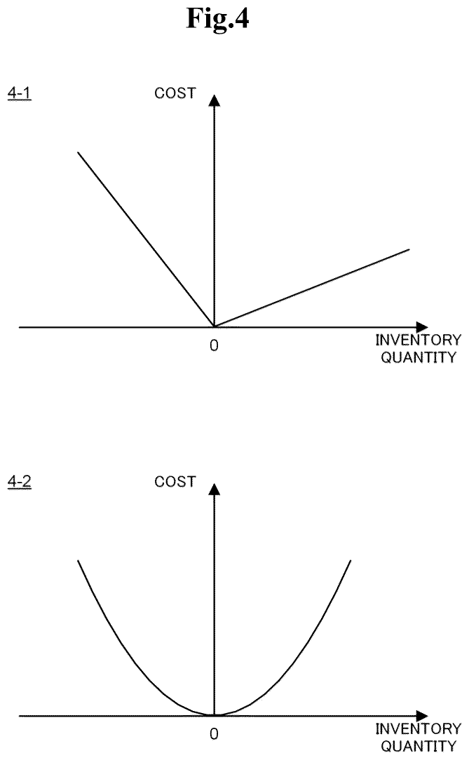

First, a technique relating to the present disclosure will be described. FIG. 3 shows an example of an algorithm updating the target inventory standard in accordance with a cost, which is a loss based on the inventory standard of the product. The cost based on the inventory quantity of the product is a convex function and, for example, as shown in FIG. 4 (4-1) and FIG. 4 (4-2), is expressed by a cost function, which is based on an inventory quantity resulting from the lapse of the demand during the period from the inventory standard, such that a cost for storage expense increases as the inventory quantity increases (surplus) and a cost for opportunity loss of sales increases as the inventory quantity becomes insufficient. The cost function shown in FIG. 4 is an example, and the cost function is not limited to the cost function shown in FIG. 4.

Then, in the algorithm shown in FIG. 3, current inventory standard yₜ, subgradient gₜ, and inventory quantity xₜ₊₁ are obtained first. Here, subgradient gₜ is expressed by a gradient in the cost function as shown in FIG. 4, for example, and represents a subdifferential in current inventory standard yₜ. Further, as shown in line 7 of the algorithm, a target inventory standard indicated by the following Formula 1 is calculated based on the previous target inventory standard and on parameter η and gradient g corresponding to a learning rate indicated by Formula (7) in FIG. 3. Then, in a case where inventory quantity xₜ₊₁ is less than or equal to the target inventory standard as shown in lines 8 and 9 of the algorithm, the target inventory standard can be updated. The source of the algorithm in FIG. 3 is as follows.

Online Inventory Problems: Beyond the i.i.d. Setting with Online Convex Optimization (Massil Hihat et al., 2023)

$${\hat{y}}_{t + 1} \qquad [ Formula 1 ]$$

On the other hand, in a case where inventory quantity xₜ₊₁ is greater than the target inventory standard as shown in lines 10 and 11 of the algorithm, current inventory standard yₜ is maintained. That is to say, in a case where demand for the product is low and the inventory quantity does not decrease significantly, the inventory standard quantity is maintained, and the product must be replenished up to the inventory standard quantity again. Here, to describe an example with numerical values, in a case where the current inventory standard is 100 units, the target inventory standard is 70 units, and the inventory quantity is 90 units, the inventory quantity of 90 unit is not below the target inventory standard of 70 units, so that the current inventory standard of 100 units is maintained, and the product needs to be replenished to meet the inventory quantity of 100 units. Therefore, the algorithm shown in FIG. 3 has a problem that the inventory cannot be reduced unless the demand increases, and therefore appropriate inventory management cannot be performed.

In order to solve the problem as described above, the information processing apparatus 10 in this example embodiment is configured in the following manner. Below, an example of the configuration and operation of the information processing apparatus 10 in this example embodiment will be described.

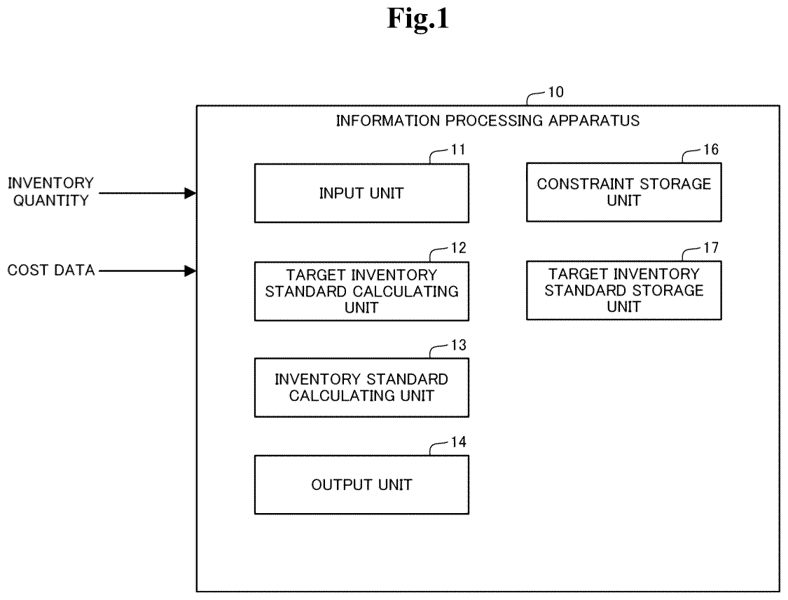

The information processing apparatus 10 is configured with one or a plurality of information processing apparatuses each including an arithmetic logic unit and a memory unit. Then, as shown in FIG. 1, the information processing apparatus 10 includes an input unit 11, a target inventory standard calculating unit 12, an inventory standard calculating unit 13, and an output unit 14. The respective functions of the input unit 11, the target inventory standard calculating unit 12, the inventory standard calculating unit 13, and the output unit 14 can be implemented by execution of a program for implementing the respective functions stored in the memory unit by the arithmetic logic unit. Further, the information processing apparatus 10 includes a constraint storage unit 16 and a target inventory standard storage unit 17 that are implemented by the memory unit.

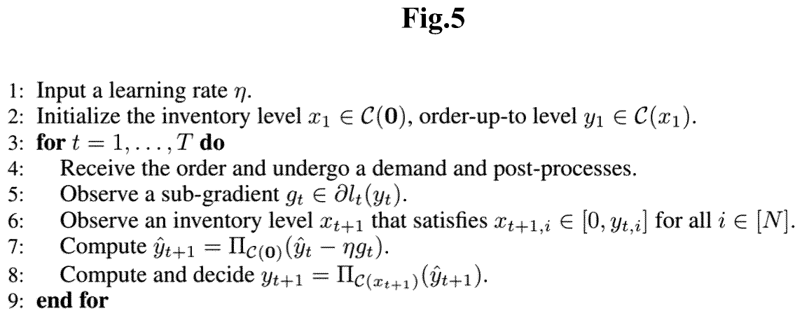

Then, the information processing apparatus 10 described above is configured to execute the processing of an algorithm shown in FIG. 5. The function and operation of each component will be described below with reference to the algorithm of FIG. 5.

First, in the constraint storage unit 16 of the information processing apparatus 10, constraint C (constraint information) of the inventory quantity of the product as indicated by Formula 2 is stored.

$$𝒞 ( x ) := \{ y ∈ {[ 0 , D ]}^{N} \vert {y}_{i} \geq {x}_{i} ∀ i ∈ [ N ] , {\sum }_{i ∈ [ N ]} {y}_{i} \leq D \} \qquad [ Formula 2 ]$$

The above constraint expresses constraint C on possible inventory standard quantity y when the current inventory y of the product is x and, for example, represents that the minimum value of the possible inventory standard quantity is x and the maximum value is D. As an example, the constraint on the inventory is set in accordance with the size and structure of a warehouse for storing the product, the size of the product, and so forth. Constraint C on the inventory may be a constraint on one product, or may be a constraint on multiple products. For example, in the case of a constraint on multiple products, the maximum value of the total of the inventories of the respective products is set as the constraint.

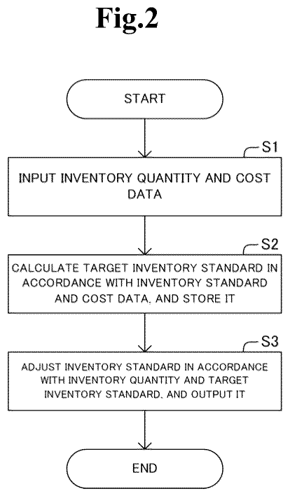

Then, as shown in lines 3 to 6 of the algorithm, the input unit 11 of the information processing apparatus 10 observes and inputs current inventory quantity xₜ₊₁, and gradient gₜ corresponding to previous period standard inventory quantity yₜ in a cost function (step S1 of FIG. 2). Here, the cost function is, as shown in FIG. 4 (4-1) and FIG. 4 (4-2) described above, a cost function such that the value of a loss increases as the inventory quantity of the product is surplus or insufficient, and changes in accordance with time. Therefore, the cost function is based on the demand in the previous period. Note that t denotes, for example, a period such as day or week.

Subsequently, the information processing apparatus 10 calculates a target inventory standard of the next period indicated by the above Formula 1 using the target inventory standard calculating unit 12 (calculating unit), and stores it into the target inventory standard storage unit 17 (step S2 of FIG. 2). To be specific, the target inventory standard calculating unit 12 calculates the current target inventory standard in accordance with the target inventory standard of the previous period and loss g based on parameter η and gradient corresponding to a learning rate as indicated by the following Formula 3, which is in line 7 of the algorithm. At this time, the target inventory standard calculating unit 12 may calculate the target inventory standard in such a manner that constraint C(0) described above is satisfied. As an example, assume that the current inventory standard, which is the target inventory standard of the previous period, is 100 units and the current target inventory standard is calculated to be 70 units.

$${\hat{y}}_{t + 1} = {\prod }_{𝒞 ( 0 )} ( {\hat{y}}_{t} = - η {g}_{t} \} \qquad [ Formula 3 ]$$

Subsequently, the information processing apparatus 10 performs adjustment of current inventory standard yₜ₊₁ using the inventory standard calculating unit 13 (adjusting unit) (step S3 of FIG. 2). To be specific, the inventory standard calculating unit 13 calculates and adjusts current inventory standard yₜ₊₁ in accordance with current inventory quantity xₜ₊₁ and the current target inventory standard indicated by Formula 1 as indicated by the following Formula 4, which is in line 8 of the algorithm. At this time, the inventory standard calculating unit 13 compares the inventory quantity with the target inventory standard in such a manner that the target inventory standard becomes an implementable value, and adjusts the inventory standard based on the comparison result. As an example, the inventory standard calculating unit 13 adjusts the value of the inventory standard in such a manner as to be the target inventory standard value itself when the target inventory standard is greater than the inventory quantity, and adjusts the value of the inventory standard in such a manner as to be the inventory quantity when the target inventory standard is less than the inventory quantity. At this time, the inventory standard calculating unit 13 may calculate the inventory standard in such a manner that constraint C described above is satisfied. As an example, assume that the value of the current inventory standard is adjusted from 100 units to the same value as the inventory quantity of 90 units.

$${y}_{t + 1} = {\prod }_{𝒞 ( {x}_{t + 1} )} ( {\hat{y}}_{t + 1} ) \qquad [ Formula 4 ]$$

Subsequently, the information processing apparatus 10 outputs the adjusted inventory standard as the current inventory standard using the output unit 14. Consequently, inventory management is performed based on the value of the adjusted inventory standard. As an example, since the current inventory quantity is 90 units and the current inventory standard is adjusted to 90 units, there is no need to further replenish the product.

Then, the information processing apparatus 10 proceeds to the next cycle, and repeats the same processing as described above (steps S1 to S3 of FIG. 2). That is to say, the information processing apparatus 10 repeatedly performs the processing of inputting the current inventory quantity and the cost data and, in the same manner as described above, calculating the target inventory standard, and adjusting and outputting the inventory standard.

Thus, in this example embodiment, it is possible to adjust and change the current inventory standard that has not been changed in the algorithm of FIG. 3 described above. Then, by repeating the abovementioned processing, it is expected that the value of the inventory standard approaches and coincides with the value of the target inventory standard eventually, and accordingly, it is expected that the value of the inventory quantity also approaches and coincides with the value of the target inventory standard. As a result, it is possible to manage the inventory quantity of the product to be an appropriate quantity.

Here, a case where the inventory standard calculating unit 13 described above adjusts in such a manner that the value of the inventory standard becomes the value of the inventory quantity has been illustrated, but it may be adjusted to another value. For example, the inventory standard calculating unit 13 may adjust the value of the inventory standard to a value between the inventory quantity and the target inventory standard and, moreover, may adjust it to a value greater than the target inventory standard. As an example, assume that both the current inventory quantities of certain products A and B are 10 units, the target inventory standard is 20 units, and the total inventory quantities of products A and B must be 30 units or less as a constraint. At this time, the inventory standards of both the products A and B cannot be the target inventory standard, but these inventory standards may be set to 15 units, which is a value between the inventory quantity and the target standard, respectively. For example, as represented by Formula 4, the value may be determined as a point in C (xₜ₊₁) with the smallest distance from the target inventory standard shown by Formula 1.

Further, regarding the target inventory standard calculating unit 12 described above, a case where the target inventory standard of the next period is calculated using the target inventory standard of the previous period and the cost function is illustrated, but the target inventory standard of the next period may be calculated by another method. For example, the target inventory standard calculating unit 12 may calculate the target inventory standard of the next period using a preset calculation formula from the target inventory standard of the previous period without using the cost function. Further, the target inventory standard calculating unit 12 may calculate the target inventory standard of the next period not limited to using the target inventory standard of the previous period, but using the target inventory standard of further past.

Further, regarding the target inventory standard calculating unit 12 and the inventory standard calculating unit 13 described above, a case where the target inventory standard and the inventory standard are calculated in such a manner as to satisfy constraints on the inventory quantity of product, respectively, is illustrated, but the target inventory standard and the inventory standard may be calculated without using the constraints. Furthermore, the constraints do not necessarily have to be set in the first place.

### Second Example Embodiment

Next, a second example embodiment of the present disclosure will be described. An information processing apparatus 10 in this example embodiment includes the same configuration as in the first example embodiment described above. In addition, the information processing apparatus 10 includes the following configuration. Hereinafter, a configuration different from the above will be mainly described.

The target inventory standard calculating unit 12 of the information processing apparatus 10 in this example embodiment may calculate the target inventory standard of the next period by using a preset product demand prediction model in addition to the cost function and the target inventory standard of the previous period described above. In this case, the demand prediction model is a model constructed to predict demand for a product based on season, temperature, date and time, day of the week, time of day, internet information, and past demand data, for example. The target inventory standard calculating unit 12 then calculates the target inventory standard in consideration of the demand based on the demand prediction model corresponding to a target period. For example, the target inventory standard calculating unit 12 may calculate the target inventory standard of the next period in consideration of adding or subtracting demand output from the demand prediction model, to or from the target inventory standard calculated based on the cost function and the target inventory standard of the previous period in the same manner as described above. At this time, the target inventory standard calculating unit 12 may calculate the target inventory standard of the next period by using the target inventory standard of the previous period and the demand prediction model, without using the cost function.

### Third Example Embodiment

Next, a third example embodiment of the present disclosure will be described. The information processing apparatus 10 in this example embodiment includes the same configuration as in the first and second example embodiments described above. In addition, the information processing apparatus 10 includes the following configuration. Hereinafter, a configuration different from the above will be mainly described.

The output unit 14 of the information processing apparatus 10 in this example embodiment has a function of calculating and outputting the replenishment quantity of product by using the inventory standard value adjusted as described above. For example, the output unit 14 compares the current inventory quantity value with the adjusted inventory standard value, and calculates and outputs a value obtained by subtracting the current inventory quantity from the inventory standard value as the replenishment quantity of product. Therefore, when the value of the inventory standard is equal to or less than the inventory quantity, the replenishment of product is not performed. Consequently, it is possible to properly manage the inventory quantity of product.

### Fourth Example Embodiment

Next, a fourth example embodiment of the present disclosure will be described. The information processing apparatus 10 in this example embodiment includes the same configuration as in the first to third example embodiments described above. Then, in this example embodiment, a product to be subjected to inventory management is not limited to an article, and may be a service. In this case, the inventory quantity of a product, the value of an inventory standard, the value of a target inventory standard, and a replenishment quantity may be the number of frames to which the service can be provided, or may be the number of persons who provide the service. Therefore, replenishment of product in the inventory management may correspond to increase of service provision time, service provision space, and the number of persons involved in service provision. As an example, a service includes a food and drink provision service by a restaurant and the like and a guest room provision service by a hotel and the like, but may be of a service of any content.

### Fifth Example Embodiment

Next, a fifth example embodiment of the present disclosure will be described with reference to the drawings. This example embodiment shows the overview of the information processing apparatus and so forth described in the above example embodiments. The drawings may be related to any of the example embodiments.

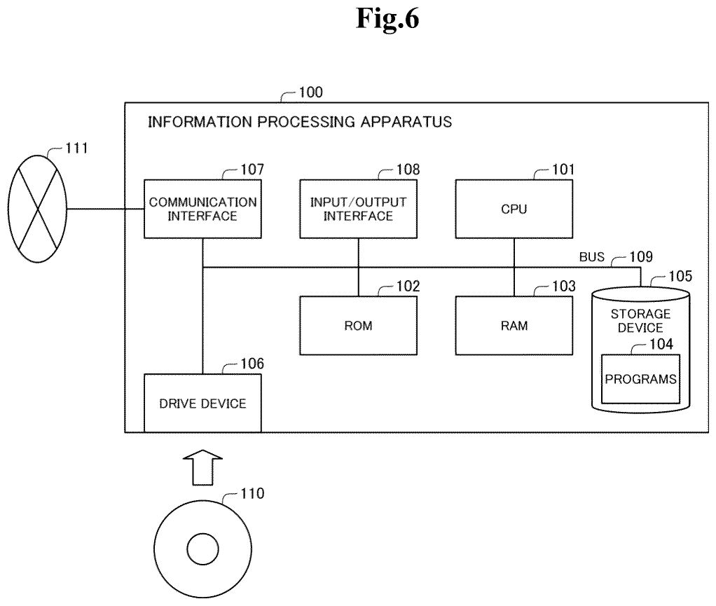

First, a hardware configuration of an information processing apparatus 100 in the present disclosure will be described. The information processing apparatus 100 is configured with a general information processing apparatus and, as an example, has the following hardware configuration as shown in FIG. 6, including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 6 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

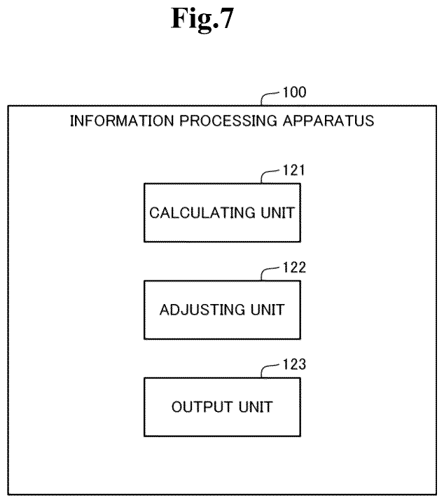

Then, the information processing apparatus 100 can construct and include a calculating unit 121, an adjusting unit 122, and an output unit 123 shown in FIG. 7 by acquisition and execution of the programs 104 by the CPU 101. The programs 104 are, for example, stored in advance in the storage device 105 or the ROM 102, and are loaded into the RAM 103 and executed by the CPU 101 as necessary. Moreover, the programs 104 may be provided to the CPU 101 via the communication network 111, or the programs may be stored in advance in the storage medium 110 and read out by the drive device 106 and provided to the CPU 101. However, the calculating unit 121, the adjusting unit 122 and the output unit 123 described above may be constructed using dedicated electronic circuits for realizing such means.

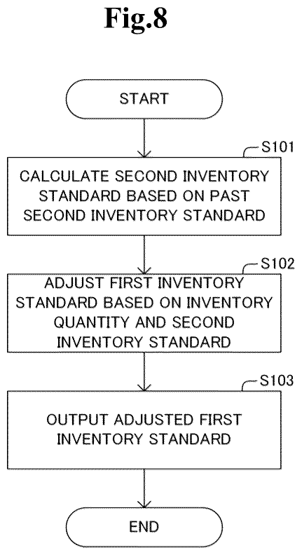

The calculating unit 121 calculates a second inventory standard that is the target value of a first inventory standard to be the standard of the inventory quantity of a product, based on the past second inventory standard (step S101 of FIG. 8). The adjusting unit 122 changes and adjusts the value of the first inventory standard based on the inventory quantity and the second inventory standard (step S102 of FIG. 8). The output unit 123 outputs the adjusted first inventory standard (step S103 of FIG. 8).

In the above configuration, the information processing apparatus 100 first calculates a second inventory standard of the next period using the past second inventory standard and cost data. Then, the information processing apparatus 100 changes and adjusts the first inventory standard in accordance with the result of comparison between the inventory quantity and the second inventory standard. For example, the information processing apparatus 100 adjusts the value of the first inventory standard to be the value of the second inventory standard itself or to be the value of the inventory quantity itself so that the second inventory standard becomes an implementable value in accordance with the inventory quantity and the second inventory standard. Then, the information processing apparatus 100 outputs the adjusted first inventory standard. As an example, in a case where the first inventory standard is 100 units, the inventory quantity is 90 units, and the second inventory standard is 70 units, the first inventory standard is adjusted to 90 units. Thus, by using the adjusted first inventory standard, it is possible to determine an appropriate replenishment quantity corresponding to the inventory quantity. That is to say, the first inventory standard is set to an appropriate value, and appropriate inventory management can be performed.

At least one or more functions of the functions of the calculating unit 121, the adjusting unit 122, and the output unit 123 described above may be executed by an information processing apparatus installed and connected anywhere on the network, that is, may be executed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), CD-ROM (Read Only Memory), CD-R, CD-R/W, and semiconductor memory (e.g., mask ROM, PROM (programmable ROM), EPROM (Erasable PROM), flash ROM, RAM (random access memory). In addition, the program may be provided to a computer by various types of transitory computer-readable medium. Examples of transitory computer-readable medium include electrical signals, optical signals, and electromagnetic waves. The transitory computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### <Supplementary Notes>

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configuration described in Supplementary Notes below.

All or some of the configurations described in Supplementary Notes 2 to 8.1 dependent on Supplementary Note 1 below and the functions by such configurations may be dependent on other Supplementary Notes 9 and 10 by the same dependence as Supplementary Notes 2 to 8.1. Furthermore, within the scope of the example embodiments described above, all or some of the configurations described in Supplementary Notes and the functions by such configurations may be dependent on hardware, software, various recording means for recording software, or system.

### (Supplementary Note 1)

An information processing apparatus comprising:
a calculating unit configured to calculate a second inventory standard, which is a target value of a first inventory standard to be a standard of an inventory quantity of a product, based on the second inventory standard in past;
an adjusting unit configured to change and adjust a value of the first inventory standard based on the inventory quantity and the second inventory standard; and
an output unit configured to output the adjusted first inventory standard.

### (Supplementary Note 2)

The information processing apparatus according to supplementary note 1, wherein
the calculating unit is configured to calculate the second inventory standard based on cost data representing a loss according to the inventory quantity and the second inventory standard in past.

### (Supplementary Note 3)

The information processing apparatus according to supplementary note 2, wherein:
the cost data includes a cost function in which as the inventory quantity of the product is surplus or insufficient, a value of the loss increases; and
the calculating unit is configured to calculate the second inventory standard based on a subgradient of the cost function and the second inventory standard in past.

### (Supplementary Note 4)

The information processing apparatus according to supplementary note 2, wherein
the calculating unit is configured to calculate the second inventory standard based on the cost data, the second inventory standard in past, and a preset product demand prediction model.

### (Supplementary Note 5)

The information processing apparatus according to supplementary note 1, wherein
the adjusting unit is configured to change and adjust the value of the first inventory standard based on comparison between the inventory quantity and the second inventory standard.

### (Supplementary Note 6)

The information processing apparatus according to supplementary note 5, wherein
the adjusting unit is configured to, in a case where the second inventory standard is greater than the inventory quantity, change and adjust the value of the first inventory standard to a value of the second inventory standard.

### (Supplementary Note 7)

The information processing apparatus according to supplementary note 5, wherein
the adjusting unit is configured to, in a case where the inventory quantity is greater than the second inventory standard, change and adjust the value of the first inventory standard to a value of the inventory quantity.

### (Supplementary Note 8)

The information processing apparatus according to supplementary note 1, wherein:
the calculating unit is configured to calculate the second inventory standard based on constraint information representing a constraint on the inventory quantity of the product; and
the adjusting unit is configured to change and adjust the value of the first inventory standard based on the constraint information.

### (Supplementary Note 8.1)

The information processing apparatus according to supplementary note 1, wherein
the output unit is configured to output a replenishment quantity of the product based on the inventory quantity and the adjusted first inventory standard.

### (Supplementary Note 9)

An information processing method comprising:
calculating a second inventory standard, which is a target value of a first inventory standard to be a standard of an inventory quantity of a product, based on the second inventory standard in past;
changing and adjusting a value of the first inventory standard based on the inventory quantity and the second inventory standard; and
outputting the adjusted first inventory standard.

### (Supplementary Note 10)

A program comprising instructions for causing an information processing apparatus to execute processes to:
calculate a second inventory standard, which is a target value of a first inventory standard to be a standard of an inventory quantity of a product, based on the second inventory standard in past;
change and adjust a value of the first inventory standard based on the inventory quantity and the second inventory standard; and
output the adjusted first inventory standard.

### REFERENCE SIGNS LIST

10 information processing apparatus
11 input unit
12 target inventory standard calculating unit
13 inventory standard calculating unit
14 output unit
16 constraint storage unit
17 target inventory standard storage unit
100 information processing apparatus
101 CPU
102 ROM
103 RAM
104 programs
105 storage device
106 drive device
107 communication interface
108 input/output interface
109 bus
110 storage medium
111 communication network
121 calculating unit
122 adjusting unit
123 output unit

1. An information processing apparatus comprising:
at least one memory storing processing instructions; and
at least one processor configured to execute the processing instructions to:
calculate a second inventory standard, which is a target value of a first inventory standard to be a standard of an inventory quantity of a product, based on the second inventory standard in past;
change and adjust a value of the first inventory standard based on the inventory quantity and the second inventory standard; and
output the adjusted first inventory standard.

2. The information processing apparatus according to claim 1, wherein the at least one processor is configured to execute the processing instructions to
calculate the second inventory standard based on cost data representing a loss according to the inventory quantity and the second inventory standard in past.

3. The information processing apparatus according to claim 2, wherein:
the cost data includes a cost function in which as the inventory quantity of the product is surplus or insufficient, a value of the loss increases; and
the at least one processor is configured to execute the processing instructions to calculate the second inventory standard based on a subgradient of the cost function and the second inventory standard in past.

4. The information processing apparatus according to claim 2, wherein the at least one processor is configured to execute the processing instructions to
calculate the second inventory standard based on the cost data, the second inventory standard in past, and a preset product demand prediction model.

5. The information processing apparatus according to claim 1, wherein the at least one processor is configured to execute the processing instructions to
change and adjust the value of the first inventory standard based on comparison between the inventory quantity and the second inventory standard.

6. The information processing apparatus according to claim 5, wherein the at least one processor is configured to execute the processing instructions to
in a case where the second inventory standard is greater than the inventory quantity, change and adjust the value of the first inventory standard to a value of the second inventory standard.

7. The information processing apparatus according to claim 5, wherein the at least one processor is configured to execute the processing instructions to
in a case where the inventory quantity is greater than the second inventory standard, change and adjust the value of the first inventory standard to a value of the inventory quantity.

8. The information processing apparatus according to claim 1, wherein the at least one processor is configured to execute the processing instructions to:
calculate the second inventory standard based on constraint information representing a constraint on the inventory quantity of the product; and
change and adjust the value of the first inventory standard based on the constraint information.

9. The information processing apparatus according to claim 1, wherein the at least one processor is configured to execute the processing instructions to output a replenishment quantity of the product based on the inventory quantity and the adjusted first inventory standard.

10. An information processing method comprising:
calculating a second inventory standard, which is a target value of a first inventory standard to be a standard of an inventory quantity of a product, based on the second inventory standard in past;
changing and adjusting a value of the first inventory standard based on the inventory quantity and the second inventory standard; and
outputting the adjusted first inventory standard.

11. The information processing method according to claim 10, comprising
calculating the second inventory standard based on cost data representing a loss according to the inventory quantity and the second inventory standard in past.

12. The information processing method according to claim 10, wherein
the cost data includes a cost function in which as the inventory quantity of the product is surplus or insufficient, a value of the loss increases, the information processing method comprising
calculating the second inventory standard based on a subgradient of the cost function and the second inventory standard in past.

13. The information processing method according to claim 11, comprising
calculating the second inventory standard based on the cost data, the second inventory standard in past, and a preset product demand prediction model.

14. The information processing method according to claim 10, comprising
changing and adjusting the value of the first inventory standard based on comparison between the inventory quantity and the second inventory standard.

15. The information processing method according to claim 14, comprising
in a case where the second inventory standard is greater than the inventory quantity, changing and adjusting the value of the first inventory standard to a value of the second inventory standard.

16. The information processing method according to claim 14, comprising
in a case where the inventory quantity is greater than the second inventory standard, changing and adjusting the value of the first inventory standard to a value of the inventory quantity.

17. The information processing method according to claim 10, comprising:
calculating the second inventory standard based on constraint information representing a constraint on the inventory quantity of the product; and
changing and adjusting the value of the first inventory standard based on the constraint information.

18. The information processing method according to claim 10, comprising
outputting a replenishment quantity of the product based on the inventory quantity and the adjusted first inventory standard.

19. A non-transitory computer-readable storage medium storing a program, the program comprising instructions for causing an information processing apparatus to execute processes to:
calculate a second inventory standard, which is a target value of a first inventory standard to be a standard of an inventory quantity of a product, based on the second inventory standard in past;
change and adjust a value of the first inventory standard based on the inventory quantity and the second inventory standard; and
output the adjusted first inventory standard.
